(19) United States
(12) Patent Application Publication
(10) Pub. No.: US 2025/0041146 A1
(43) Pub. Date: Feb. 6, 2025

(54) TRACTION DEVICE

(71) Applicant: HUNG JANG TANG, Kaohsiung City (TW)

(72) Inventor: HUNG JANG TANG, Kaohsiung City (TW)

(21) Appl. No.: 18/791,537

(22) Filed: Aug. 1, 2024

(30) Foreign Application Priority Data
Aug. 4, 2023 (TW) 112129292

(51) Int. Cl. A61H 1/02

(52) U.S. Cl. CPC A61H 1/0222; A61H 2201/1604; A61H 2201/1611; A61H 2201/1616; A61H 2201/1642

(57) ABSTRACT

A traction device comprising: a bed frame with a bed board placed on top of the bed frame, the bed board includes four bed board sections: wherein the first bed board section is movable, featuring an ergonomic cervical cushion, a head fixing device that fully encloses the head, and a chin strap; the second bed board section is fixed, equipped with multiple stoppers that are adjustable according to the users body shape, including shoulder stoppers for counteracting cervical traction and armpit stopper shafts for counteracting thoracic and lumbar traction; the third bed board section is movable, featuring an ergonomic lumbar cushion and iliac stoppers that are adjustable according to the users body shape; and the fourth bed board section is movable, with multiple foot fixing devices composed of an upper part shaped to the arc of the dorsum of the foot and a lower part shaped to the arc of the heel.

### CROSS-REFERENCE TO RELATED APPLICATIONS

This application claims the benefit of priority of Taiwan Application Number TW 112129292, filed on 4 Aug. 2023, which is herein incorporated by reference in its entirety.

### TECHNICAL FILED

The present disclosure relates to a human traction device, specifically a human traction device that may be elastically adjusted according to the user's body shape and may provide linear traction simultaneously to any one or multiple parts of the cervical, thoracic, lumbar spine, and pelvis-lower limb regions based on the user's needs.

### BACKGROUND

Existing cervical or lumbar traction devices mainly fall into two categories: seated and lying. However, these devices often do not account for individual body differences or ergonomic design, not only it cannot fulfil the comfortability requirement for users, it may also lead to potential secondary injuries during traction therapy due to incompatibility between the users figure and the device.

Furthermore, due to the complex human skeletal structure, problems in one area may often lead to issues in other areas. Existing traction devices only stretch specific parts of a human body, thereby it requires more than twice the time and different tools for stretching multiple areas. Also, the existing traction devices comprise complex structures, which necessitate professional operation and assessment, making rehabilitation time-consuming, costly, and less safe.

To address the above-mentioned issues, the present disclosure provides a traction device with ergonomically designed components, some components are made of elastic materials to reduce the user's discomfort. The components' position and opening degree may be adjusted according to the user's body shape, preventing secondary injuries during stretching.

Additionally, with multiple movable bed board sections and designs of multiple stoppers providing counteracting force for cervical, thoracic, lumbar, and pelvis-lower limb regions, the device provides effective linear traction of any one or multiple areas of cervical, thoracic, lumbar, and pelvis-lower limb regions according to the user's need. It effectively improves and treats discomfort in various areas according to rehabilitation medical principles, it also provides users with a comfortable experience, prevents secondary injuries, and reduces the time and cost of traditional rehabilitation.

Moreover, the present disclosure not only solves joint-related problems but also aids in relaxing tense muscles, tendons, or ligaments. Since such discomfort is often caused by tissue adhesion and nerve root compression, using the traction device for rehabilitation may stretch the adhered and compressed areas, effectively and quickly relieving pain and improving joint mobility.

Additionally, the novel and ingenious design of the present disclosure allows for easy use without extensive training. Both professionals and ordinary consumers including patients themselves, may set parameters and operate the traction device of the present disclosure easily, ensuring a user-friendly experience without safety concerns.

### SUMMARY

The present disclosure aims to provide a traction device featuring ergonomic and comfortable components, which may be adjusted according to the user's rehabilitation needs. It enables linear traction of any single part or multiple parts of the cervical, thoracic, lumbar spine, pelvis-lower limb region and its corresponding muscle, tendon, ligament and vertebrae, facilitating effective stretching of the affected area. This helps in treating tissue adhesions, nerve root compression, spinal injuries, and misalignment of vertebrae.

In order to achieve the above purpose, the present disclosure provides the following embodiments.

In one aspect, the present disclosure provides a traction device, comprising: a bed frame, and a bed board disposed on the bed frame;
the bed board comprises four bed board sections, which is a first bed board section, a second bed board section, a third bed board section, and a fourth bed board section respectively;
the first bed board section is movable by setting slide rails on both sides, and the first bed board section is provided with:
a cervical cushion, for placing the neck of a human body, which is made of elastic material, with a curvature corresponding to a human cervical spine;
a head fixing device, for completely covering a head of the human body, wherein a main body of the head fixing device is composed of an iron plate wrapped with elastic material, and a lower left end and a lower right end are respectively fixed to the first bed board section with iron pieces; the head fixing device is fixed to the user's forehead with a strap, and adhesive parts are respectively provided on left and right outer sides, with two ends of a chin strap connected to the adhesive parts;
the second bed board section is fixed, and the second bed board section is provided with:
a plurality of shoulder stoppers, providing counteracting force for stretching a cervical spine, the shoulder stoppers are composed of an iron plate wrapped with elastic material, the shoulder stoppers are installed on the second bed board section with a rotating shaft rod, the shoulder stoppers are slightly inclined forward by 25 degrees to match a curvature of a human shoulder and neck;
when not in use, the shoulder stoppers are stored parallel downwards; when in use, the shoulder stoppers may rotate upwards to resist an upper end of the human shoulder, and may slide left and right in the direction parallel to the width of the bed board, adjusted to an appropriate position of the shoulder peak according to the width of the human shoulder, and then fixed;
a plurality of armpit stopper shafts, providing counteracting force for stretching a thoracic and lumbar spine, the armpit stopper shafts are composed of iron shafts wrapped with elastic material, respectively fixed under armpits on both sides of the human body, the armpit stopper shafts are installed with shaft rods;
when not in use, the armpit stopper shafts are stored parallel downwards; when in use, the armpit stopper shafts may rotate upwards to resist human armpits, and may slide left and right in the direction parallel to the width of the bed board, adjusted to an appropriate position according to the width of the human armpits, and then fixed;
the third bed board section is movable by setting slide rails on both sides, and the third bed board section is provided with:
a lumbar cushion, for placing the waist of a human body, with a curvature corresponding to a human lumbar spine;
a plurality of iliac stoppers, the iliac stoppers are composed of an iron plate wrapped with elastic material, respectively used to fix an upper edge of an iliac crest on both sides of the human body, the iliac stoppers are installed with shaft rods, and designed to be slightly inclined forward by 5 degrees; when not in use, the iliac stoppers are stored parallel downwards, and when in use, the iliac stoppers are rotated upwards and adjusted to an appropriate position according to an user's body shape, and then fixed;
the fourth bed board section is movable by setting slide rails on both sides, and the fourth bed board section is provided with:
a plurality of foot fixing devices, covering feet of the human body, having an upper part and a lower part, the upper part is made according to the curvature of a dorsum of a human foot, the lower part is made according to the curvature of a heel of a human ankle, the two upper parts are connected by a connecting component, the two lower parts are connected by another connecting component, the upper part and the lower part may be adjusted to an user's foot shape by adjusting the connecting component.

In some embodiments, the shoulder stopper of the present disclosure is installed on the second bed board section using a rotating shaft rod.

In some embodiments, the armpit stopper shaft of the present disclosure is installed on the second bed board section using a rotating shaft rod.

In some embodiments, the iliac stopper of the present disclosure is installed on the third bed board section using a rotating shaft rod.

In some embodiments, the shoulder stopper of the present disclosure is installed on the second bed board section using a shaft rod composed of screw rod rotating wheels and screw rods.

In some embodiments, the armpit stopper shaft of the present disclosure is installed on the second bed board section using a shaft rod composed of screw rod rotating wheels and screw rods.

In some embodiments, the iliac stopper of the present disclosure is installed on the third bed board section using a shaft rod composed of screw rod rotating wheels and screw rods.

In some embodiments, the elastic materials used in the present disclosure include, but are not limited to, foam, latex, rubber, or sponge.

In some embodiments, a front end of the first bed board section, a rear end of the third bed board section, and a rear end of the fourth bed board section of the present disclosure are respectively provided with hook rings connected to an electronic traction equipment, such as a digital fine-tuning traction device;
according to an user's needs for stretching parts, the electronic traction equipment is connected to corresponding hook rings, when the electronic traction equipment pulls the bed board sections and stretches the human body in a direction parallel to the human body and away from the center of the second bed board section, the plurality of stoppers, the plurality of stopper shafts, and the foot fixing devices provide counteracting force, allowing the traction device to stretch a cervical spine, thoracic spine, lumbar spine, pelvis, and lower limbs of a human body.

In some embodiments, the cervical cushion of the present disclosure has an arc-shaped structure that is lower on both sides and gradually arches inward, having a physiological curvature of a cervical spine ranging from 22 to 24 degrees from both sides to a center raised portion.

In some embodiments, the lumbar cushion of the present disclosure has an arc-shaped structure that is lower on both sides and gradually arches inward, the arch has a curvature of 26 degrees corresponding to a human lumbar spine from both sides to a center raised portion.

In some embodiments, the iliac stoppers of the present disclosure are designed based on the structure of the upper edge of the iliac crest and are slightly inclined forward by 5 degrees.

In some embodiments, the electronic traction equipment of the present disclosure may connect to the hook ring at the front end of the first bed board section and optionally to the hook rings at the rear ends of other sections to correspond to the parts of the body that the user wishes to stretch, wherein the electronic traction equipment connects to the hook ring at the front end of the first bed board section of the bed board to apply linear traction to a cervical spine of a human body for stretching; or
the electronic traction equipment connects to the hook rings at the front end of the first bed board section and the hook rings at the rear end of the third bed board section to simultaneously apply linear traction to the cervical, thoracic, and lumbar spine of the human body for stretching; or
the electronic traction equipment connects to the hook rings at the front end of the first bed board section, the hook rings at the rear end of the fourth bed board section, and optionally the hook rings at the rear end of the third bed board section to simultaneously apply linear traction to the cervical, thoracic, lumbar spine, and pelvis-lower limb region of the human body for stretching.

In some embodiments, the electronic traction equipment of the present disclosure connects to the hook ring at the rear end of the third bed board section to apply linear traction to the thoracic and lumbar spine of a human body for stretching; or
the electronic traction equipment connects to the hook rings at the rear end of the third bed board section and the hook rings at the rear end of the fourth bed board section to simultaneously apply linear traction to the thoracic, lumbar spine, and pelvis-lower limb region of the human body for stretching.

In some embodiments, the electronic traction equipment of the present disclosure connects to the hook ring at the rear end of the fourth bed board section to apply linear traction to the pelvis-lower limb region of the human body for stretching.

In another embodiment, the present disclosure provides a traction device according to the above embodiments, comprising: an electric pump controlling a hydraulic rod between any two of the first bed board section, the second bed board section, the third bed board section, and the fourth bed board section, which in turn moves a linkage rod back and forth for stretching, users may adjust the hydraulic rod's vertical movement to apply linear traction to the cervical, thoracic, lumbar spine, and pelvis-lower limb region for stretching.

Compared to prior art, the traction device of the present disclosure features a novel structure, including ergonomic components, adjustable straps and stoppers that securely and comfortably fix the user to the traction device. This facilitates traction and stretching operations, prevents accidental falls, and avoids secondary injuries.

Moreover, the design of multiple movable bed board sections allows linear traction of any single or multiple parts of the cervical spine, thoracic spine, lumbar spine, pelvis-lower limbs and its corresponding muscles, tendons, ligaments, and vertebrae. By correcting the compression points of the spinal nerves of the upper and lower vertebral bodies, realignment of the bones enables smooth nerve conduction and restores normal function. It offers enhanced effectiveness and safety during operation, reducing the time and cost involved in the rehabilitation process.

Therefore, the traction device of the present disclosure not only helps address joint related issues but also promotes the realignment of the skeletal structure and improves blood circulation in soft tissues. It effectively relaxes tense muscles, fascia, tendons, and ligaments, alleviating spasms and reducing pain. Furthermore, the present disclosure is easy to operate, allowing both professionals and ordinary users, including the users themselves, to easily use the present disclosure by setting parameters based on individual data.

### BRIEF DESCRIPTION OF THE DRAWINGS

FIG. 1 is a top view of the overall structure of the exemplary first embodiment of the present disclosure.

FIG. 2 is a side view of the overall structure of the exemplary first embodiment of the present disclosure observed from the Y direction.

FIG. 3 is a side view of the overall structure of the exemplary first embodiment of the present disclosure observed from the X direction.

FIG. 4 is a schematic diagram of the slide rail of the traction device shown in FIG. 1.

FIG. 5 is a schematic diagram of the cervical cushion of the traction device shown in FIG. 1 observed from the X direction.

FIG. 6 is a schematic diagram of the head fixing device of the traction device shown in FIG. 1 observed from the X direction.

FIG. 7 is a schematic diagram of the rotating shaft rod shoulder stopper of the traction device shown in FIG. 1 observed from the X direction.

FIG. 8 is a schematic diagram of the shaft rod armpit stopper shaft consisting of the screw rod rotating wheel and the screw rod of the traction device shown in FIG. 1 observed from the X direction.

FIG. 9 is a schematic diagram of the shaft rod iliac stopper shaft consisting of the screw rod rotating wheel and the screw rod of the traction device shown in FIG. 1 observed from the X direction.

FIG. 10 is a schematic diagram of the foot fixing device of the traction device shown in FIG. 1 observed from the X direction.

FIG. 11 is an in-use state diagram of the traction device shown in FIG. 1

FIG. 12 is a schematic perspective view of the traction device shown in FIG. 1.

FIG. 13 is a schematic side view of the overall structure of the exemplary second embodiment of the present disclosure.

FIG. 14 is a schematic perspective view of the screw rod of the present disclosure.

### DETAILED DESCRIPTION

The following describes the traction device of the present disclosure through exemplary embodiments. It should be noted that the following exemplary embodiments are provided to illustrate the detailed content and implementation effects of the present disclosure and are not intended to limit the scope of the present disclosure.

### First Embodiment

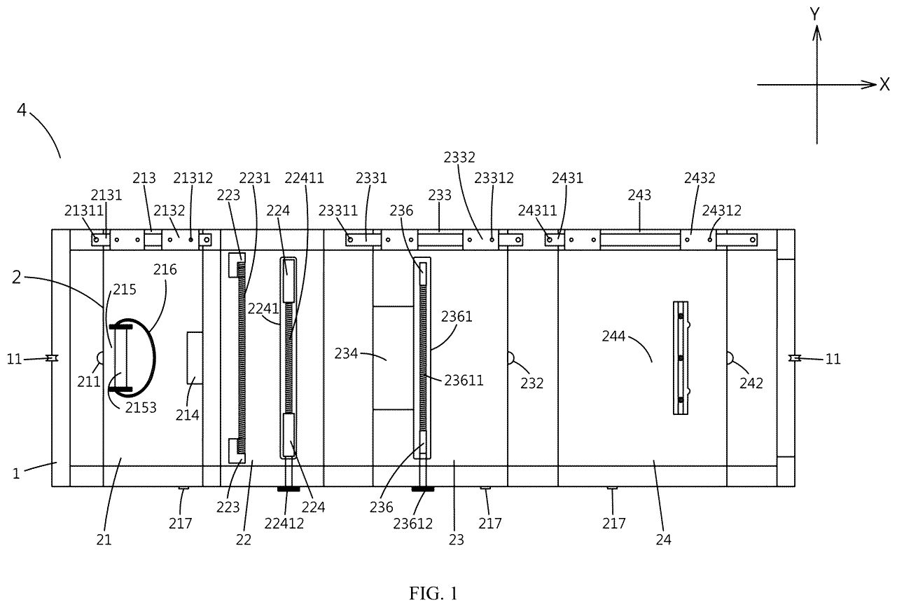

FIGS. 1 to 12 illustrate a traction device according to the exemplary first embodiment of the present disclosure, which consists of a bed frame (1), a bed board (2), and an electronic traction device (3) forming the traction device (4). The bed frame (1) may have fixed wheels (not shown) at the bottom of multiple leg posts to facilitate movement of the device and to stabilize the bed frame (1) after relocation to prevent sliding.

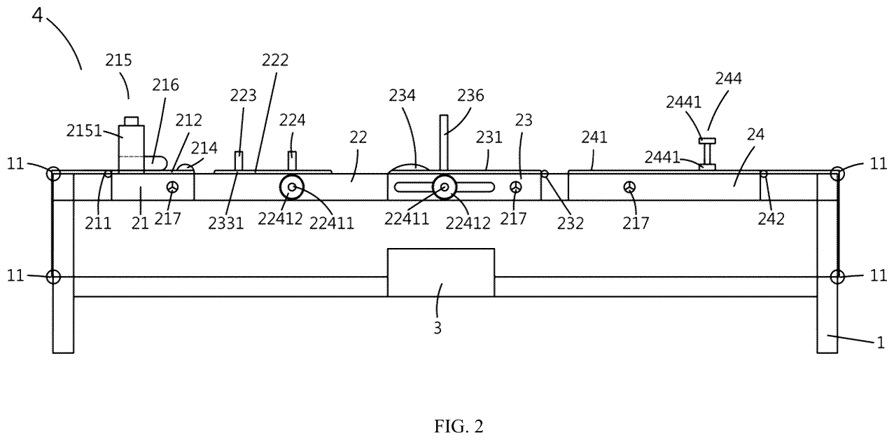

As shown in FIGS. 1 and 2, the front leg post and rear leg post on the central axis of the bed frame (1) are each equipped with two rollers (11) at their top and middle positions. These rollers (11) are used to fix the position of the traction ropes connecting the traction device to the hook rings, achieving the purpose of linear traction.

The bed board (2) consists of four bed board sections, which is the first bed board section (21), the second bed board section (22), the third bed board section (23), and the fourth bed board section (24) respectively.

The first bed board section (21), the second bed board section (22), the third bed board section (23), and the fourth bed board section (24) are each equipped with mattresses (212, 222, 231, 241) made of elastic materials such as sponge, foam, latex, silicone, or rubber.

Considering the safety of users getting on and off the traction device, bed board fixing devices (217) composed of screws are installed on the sides of the movable first bed board section (21), the movable third bed board section (23), and the movable fourth bed board section (24). These bed board fixing devices (217) temporarily lock the movable first bed board section (21), the movable third bed board section (23), and the movable fourth bed board section (24) to the bed frame to prevent the bed board from moving freely on the slide rails due to the user's movement or external force on the traction device, thus ensuring user safety when in use.

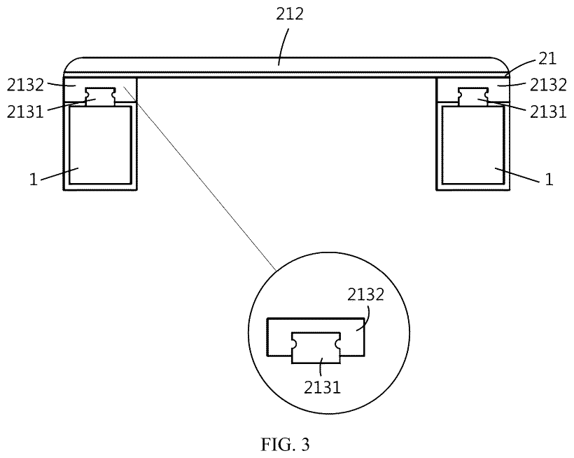

As shown in FIG. 3, the bed frame (1) is composed of a larger rectangular iron piece covering a smaller rectangular iron piece, achieving the effect of a sturdy overall structure for the traction device. Furthermore, the slider is fixed to the movable bed board section with screws, and the slide rail track is fixed to the bed frame (1) with screws. Exemplarily, the enlarged view at the lower right of FIG. 3 shows that the slider (2132) is fixed to the movable first bed board section (21) with screws, the slide rail track (2131) is fixed to the bed frame (1) with screws, and the slider (2132) is embedded to fit onto the slide rail track (2131).

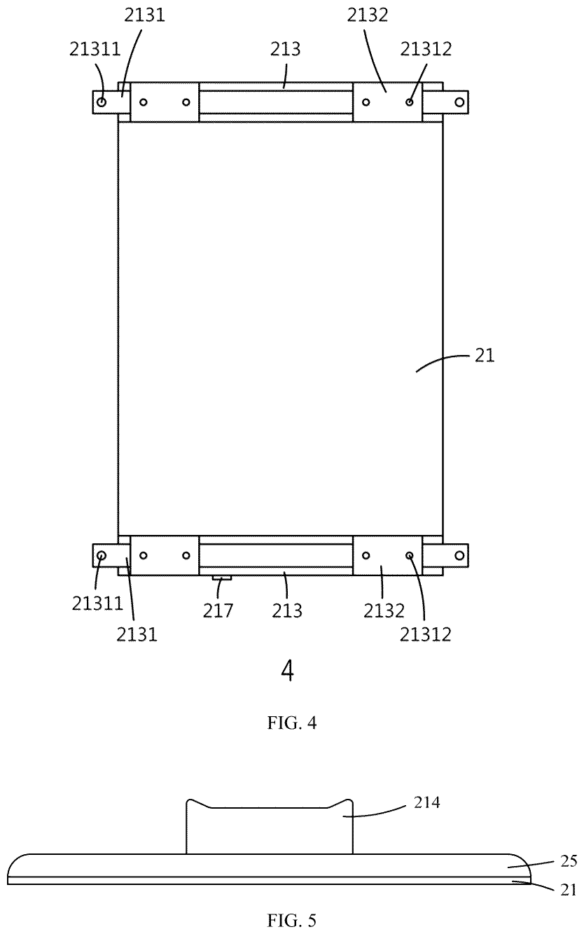

The movable first bed board section (21), the movable third bed board section (23), and the movable fourth bed board section (24) move along slide rails set on both sides. As shown in FIG. 4, the movable first bed board section (21) moves via slide rails (213) set on both sides, with the slide rail track (2131) fixed to the bed frame (1) with screws (21311), and multiple sliders (2132) fixed to the first bed board section (21) with screws (21312). The movable third bed board section (23) moves via slide rails (233) set on both sides, with the slide rail track (2331) fixed to the bed frame (1) with screws (23311), and multiple sliders (2332) fixed to the third bed board section (23) with screws (23312). The movable fourth bed board section (24) moves via slide rails (243) set on both sides, with the slide rail track (2431) fixed to the bed frame (1) with screws (24311), and multiple sliders (2432) fixed to the fourth bed board section (24) with screws (24312). The fixed second bed board section (22) is welded to the bed frame (1), ensuring it remains stationary during the traction process.

The front end of the movable first bed board section (21) is equipped with a front end hook ring (211) connected to the electronic traction device (3). Slide rails (213) are set on both sides of the first bed board section (21), allowing it to move parallel to the direction of the human body (i.e., the X direction as shown in FIG. 1) when the electronic traction device (3) pulls the front end hook ring (211).

In some embodiments, the movable first bed board section (21) may further include adjustable slide rail fixing elements (not shown) to secure the first bed board section (21) in any desired position along the slide rail (213).

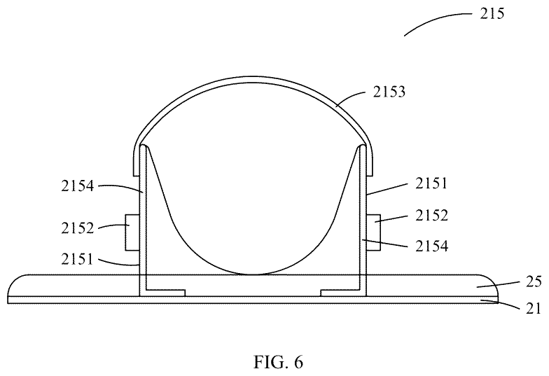

The first bed board section (21) is equipped with: a cervical cushion (214) made of elastic materials such as sponge, foam, latex, silicone, or rubber for the neck, with an arc of 22 to 24 degree corresponding to the curvature of the cervical spine, as shown in FIG. 5; a head fixing device (215) that fully accommodates the human head, with the main body (2151) of the head fixing device made of elastic materials such as sponge, foam, latex, silicone, or rubber covering an iron plate. The lower left and right ends are fixed to the first bed board section (21) with iron pieces (2154). Accordingly, the iron pieces (2154) secure the positioning of the head fixing device (215). When the user's head is placed, the elastic material of the main body (2151) wraps inward or outward according to the head shape, fully covering the head due to its elasticity. The strap (2153) secures the user's forehead and may be adjusted for head circumference, as shown in FIG. 6.

Additionally, adhesive parts (2152) are further set on the left and right outer sides of the head fixing device (215). The two ends of the chin strap (216) (refer to FIG. 2) are connected to these adhesive parts (2152). The chin strap (216) is adjustable in length and may include but is not limited to belt-type designs.

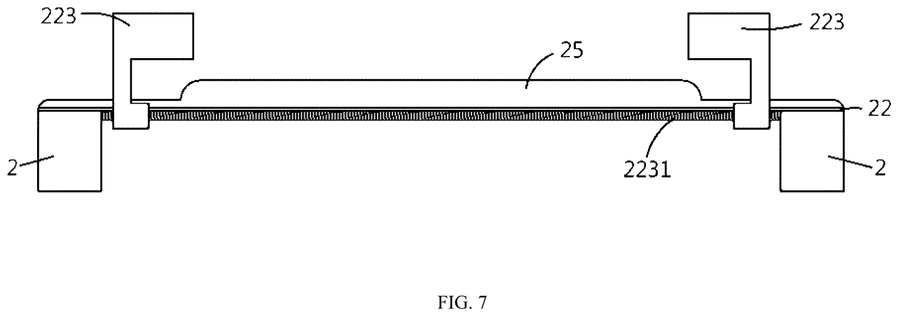

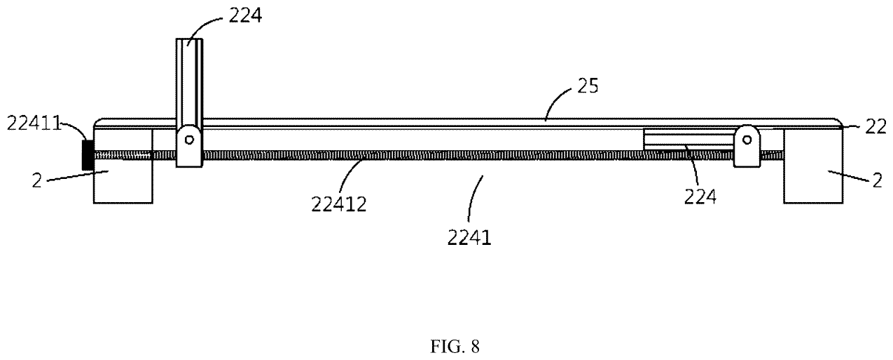

The fixed second bed board section (22) is equipped with shoulder stoppers (223) made of iron plates covered with elastic materials such as sponge, foam, latex, silicone, or rubber that provide counteracting force for stretching the cervical spine by resting against the shoulders as shown in FIG. 7. Additionally, as shown in FIG. 8, armpit stopper shafts (224), composed of iron shafts covered with elastic materials such as sponge, foam, latex, silicone, or rubber, secures the user's armpits to provide counteracting force for stretching the lumbar and thoracic spine.

In one embodiment, the multiple shoulder stoppers (223) of the present disclosure are installed on the second bed board section (22) using rotating shaft rods (2231). These shoulder stoppers are slightly inclined forward by 25 degrees to match the curvature of the human shoulder and neck. When not in use, the shoulder stoppers (223) are stored downward. When in use, they may rotate upward to rest against the upper ends of the shoulders and slide along the rotating shaft rods (2231) shown in FIG. 7 in the direction parallel to the width of the second bed board section (22) (i.e., the Y direction as shown in FIG. 1). The shoulder stoppers (223) are then adjusted to the appropriate position of the acromion according to the shoulder width and fixed in place. In the usage state, the shoulder stoppers (223) are set approximately parallel to the Y direction; however, it is also understood by those skilled in the art that the shoulder stoppers (223) may also be set approximately perpendicular to the X-Y direction in the usage state.

In one embodiment, the multiple shoulder stoppers (223) of the present disclosure are installed on the second bed board section (22) using a shaft rod composed of screw rod rotating wheels and screw rods. The shoulder stoppers are slightly inclined forward by 25 degrees to match the curvature of the shoulder and neck. When not in use, the shoulder stoppers (223) are stored downward. When in use, the shoulder stoppers (223) rotate upward to rest against the upper ends of the shoulders and slide along the rotating shaft in the direction parallel to the width of the second bed board section (22) (i.e., the Y direction as shown in FIG. 1). The shoulder stoppers (223) are then adjusted to the appropriate position of the acromion according to the shoulder width and fixed in place. In the usage state, the shoulder stoppers (223) are set approximately parallel to the Y direction; however, it is understood by those skilled in the art that the shoulder stoppers (223) may also be set approximately perpendicular to the X-Y direction in the usage state. When using multiple shoulder stoppers (223), the screw rod rotating wheel at the front of the screw rod may be turned to drive the two shoulder stoppers (223) along the shaft rod, moving inward or outward simultaneously in the Y direction. Once adjusted to fit the user's body, the nut on the screw rod is fixed, thereby securing the position of the shoulder stoppers (223).

In one embodiment, multiple armpit stopper shafts (224) are installed on the second bed board section (22) using a shaft rod (2241) composed of screw rod rotating wheels (22412) and screw rods (22411), to be fixed under the armpits on both sides of the human body. When not in use, the armpit stopper shafts (224) are stored downward. When in use, the armpit stopper shafts (224) rotate upward to support the armpits and slide along the rotating shaft in the direction parallel to the width of the second bed board section (22) (i.e., the Y direction as shown in FIG. 1) as shown in FIG. 8. Armpit stopper shafts (224) are then adjusted to the appropriate position according to the width of the user's armpits and fixed in place.

The armpit stopper shafts (224) of the present disclosure may be installed on the second bed board section (22) using a shaft rod (2241). When in use, the screw rod rotating wheel (22412) at the front of the screw rod (22411) may be rotated so that the screw rod (22411) drives the two armpit stopper shafts (224) along the shaft rod (2241), moving inward or outward simultaneously in the Y direction. Once adjusted to fit the user's body, the nut on the screw rod (22411) is fixed, securing the position of the armpit stopper shafts (224).

In one embodiment, the multiple armpit stopper shafts (224) of the present disclosure are installed on the second bed board section (22) using rotating shaft rods. When not in use, the armpit stopper shafts (224) are stored downward. When in use, the armpit stopper shafts (224) rotate upward to support the armpits and slide along the rotating shaft rod in the direction parallel to the width of the second bed board section (22) (i.e., the Y direction as shown in FIG. 1). The armpit stopper shafts (224) are then adjusted to the appropriate position according to the user's body width and fixed in place. In the usage state, the armpit stopper shafts (224) are set approximately parallel to the Y direction; however, it is understood by those skilled in the art that the armpit stopper shafts (224) may also be set approximately perpendicular to the X-Y direction in the usage state.

Moreover, the first bed board section (21) is movable, while the second bed board section (22) is fixed, there is a gap between the first bed board section (21) and the second bed board section (22) to accommodate different neck lengths of users. The traction device of the present disclosure effectively stretches the cervical spine and corresponding muscles, tendons, and ligaments such as the splenius capitis, trapezius, and sternocleidomastoid muscles, through the combination of the movable first bed board section (21), the fixed second bed board section (22), and the shoulder stoppers (223), which provides counteracting force, unlike previous technologies that only stretch soft tissues.

The rear end of the movable third bed board section (23) is equipped with a rear end hook ring (232) connected to the electronic traction device (3). Slide rails (233) are set on both sides of the third bed board section (23), allowing it to move parallel to the direction of the human body (i.e., the X direction as shown in FIG. 1) when the electronic traction device (3) pulls the rear end hook ring (232). In some embodiments, it may further include adjustable slide rail fixing component (not shown) to secure the third bed board section (23) at any desired position along the slide rail (233).

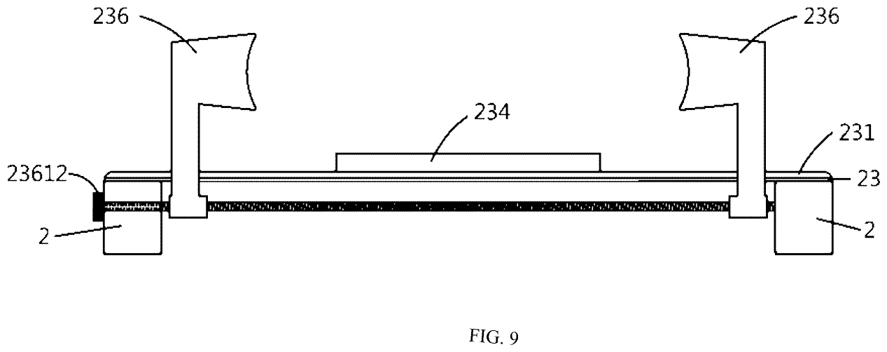

The third bed board section (23) is equipped with a lumbar cushion (234) made of elastic materials such as sponge, foam, latex, silicone, or rubber, as shown in FIG. 9. The lumbar cushion (234) is designed for placing the waist and has a structure that is lower on the sides and gradually arches inward, with a 26-degree curvature corresponding to the lumbar spine. The third bed board section (23) is also equipped with multiple iliac stoppers (236) made of elastic materials such as sponge, foam, latex, silicone, or rubber, and iron plates, as shown in FIG. 9, to secure the upper edges of the iliac crest on both sides of the human body.

In one embodiment, the iliac stoppers (236) are installed using a shaft rod (2361) composed of screw rod rotating wheels (23612) and screw rods (23611), and are designed to be slightly inclined forward by 5 degrees. When not in use, the iliac stoppers (236) are stored downward. During use, the iliac stoppers (236) may be rotated upward and adjusted to fit the user's body shape before being fixed in place. The iliac stoppers (236) are designed with a curvature that matches the structure of the upper edge of the iliac crest, ensuring they fit appropriately to the iliac crest's upper ridge. Additionally, the iliac stoppers (236) are set at a slight forward tilt of approximately 5 degrees for safety.

Similarly, the iliac stoppers (236) of the present disclosure may be connected to the third bed board section (23) using a shaft rod (2361). During use, the screw rod rotating wheel (23612) at the front of the screw rod (23611) may be rotated so that the screw rod (23611) drives the two iliac stoppers (236) simultaneously inward or outward in the Y direction. Once adjusted to fit the user's body shape, the nut on the screw rod (23611) is fixed, securing the position of the iliac stoppers (236).

In one embodiment, the multiple iliac stoppers (236) of the present disclosure are installed on the third bed board section (23) using rotating shaft rods and are designed with a curvature to match the upper edge of the iliac crest, ensuring they fit appropriately and are slightly inclined forward by 5 degrees. When not in use, the iliac stoppers (236) are stored downward. When in use, the iliac stoppers (236) rotate upward to support the upper edge of the iliac crest, and may slide along the rotating shaft rod in the direction parallel to the width of the third bed board section (23) (i.e., the Y direction as shown in FIG. 1). The iliac stoppers (236) are then adjusted to fit the user's body width and fixed in place. In the usage state, the iliac stoppers (236) are set approximately parallel to the Y direction; however, it is understood by those skilled in the art that the iliac stoppers (236) may also be set approximately perpendicular to the X-Y direction.

In the above embodiments, when not in use, the shoulder stoppers (223), the armpit stopper shafts (224), and the iliac stoppers (236) are stored downward, perpendicular to the X-Y direction. It should be understood that any or all of the shoulder stoppers (223), armpit stopper shafts (224), and iliac stoppers (236) may also be stored parallel to the X direction when not in use. This invention does not restrict this configuration.

The rear end of the movable fourth bed board section (24) is equipped with a rear end hook ring (242) connected to the electronic traction device (3). Slide rails (243) are set on both sides of the fourth bed board section (24), allowing it to move parallel to the direction of the human body (i.e., the X direction as shown in FIG. 1) when the electronic traction device (3) pulls the rear end hook ring (242). In some embodiments, it may further include adjustable slide rail fixing components (not shown) to secure the fourth bed board section (24) at any desired position along the slide rail (243).

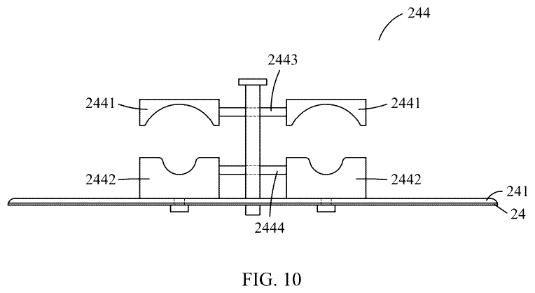

The fourth bed board section (24) is equipped with foot fixing devices (244) as shown in FIG. 10. The foot fixing devices (244) devices may securely cover both feet and feature ergonomically designed upper parts (2441) and lower parts (2442). The upper parts (2441) are shaped to fit the curvature of the dorsum of the feet, while the lower parts (2442) are shaped to fit the curvature of the heels. Two upper parts (2441) are connected by a connecting component (2443), and two lower parts (2442) are connected by another connecting component (2444).

Accordingly, the traction device (4) of the present disclosure allows users to perform effective stretching while lying flat, and a person skilled in the field should understand that the lying position is recognized as the most comfortable state and may achieve optimal stretching results. Moreover, the present disclosure uses multiple fixing devices, stopper shafts, and stoppers to ensure linear traction of the cervical, thoracic, and lumbar spine, pelvis-lower limb region. Unlike previous technologies, this design prevents force lines from skewing, which would otherwise only stretch the surface soft tissues without achieving simultaneous traction of the spine, tendons, and ligaments.

The traction device (4) of the present disclosure may accommodate the needs of different affected areas for different users by connecting the electronic traction device (3) to the hook ring of a movable bed board section and performing stretching. The traction device (4) may stretch only one part at a time, for example stretching the cervical spine, thoracic spine, lumbar spine, or pelvis-lower limb region one at a time.

Moreover, the traction device (4) of the present disclosure may also be adjusted according to the needs of different affected areas for different users. By connecting the electronic traction device (3) to the hook rings of various bed board sections, it may simultaneously stretch multiple areas or just a single area. For example, it may stretch only the cervical spine, only the thoracic and lumbar spine, simultaneously stretch the cervical, thoracic, and lumbar spine, simultaneously stretch the thoracic spine, lumbar spine, and pelvis-lower limb region, or simultaneously stretch the cervical spine, thoracic spine, lumbar spine, and pelvis-lower limb region, or only stretch the pelvis-lower limb region.

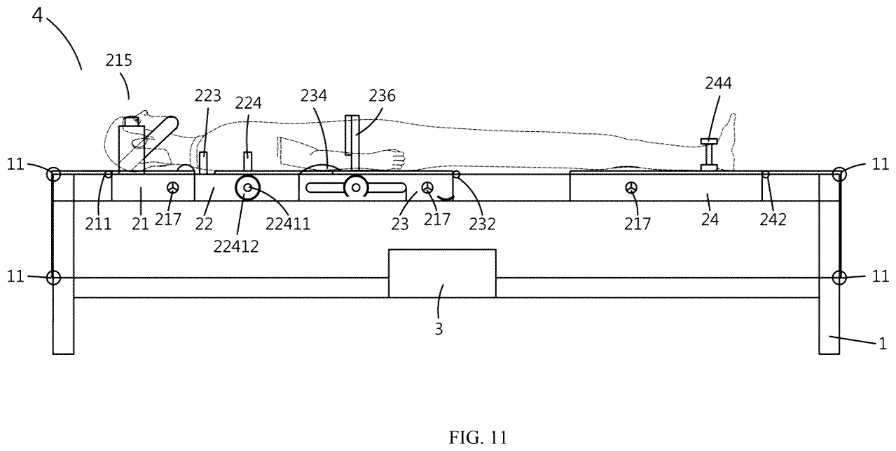

FIG. 11 shows a usage state diagram of the traction device (4) in one embodiment. In this embodiment, the traction device (4) connects the electronic traction equipment (3) to the front end hook ring (211) of the first bed board section and the rear end hook ring (242) of the fourth bed board section. By not fixing the slide rail (233) of the third bed board section (23), it simultaneously provides linear traction to the cervical spine and pelvis-lower limb region for stretching.

In one embodiment, the traction device (4) of the present disclosure provides linear traction to the cervical spine for stretching by connecting the electronic traction equipment (3) to the front end hook ring (211) of the first bed board section and stretching.

In one embodiment, the traction device (4) of the present disclosure provides linear traction to the thoracic and lumbar spine for stretching by connecting the electronic traction equipment (3) to the rear end hook ring (232) of the third bed board section.

In one embodiment, the traction device (4) of the present disclosure simultaneously provides linear traction to the cervical spine and the thoracic and lumbar spine for stretching by connecting the electronic traction equipment (3) to the front end hook ring (211) of the first bed board section and the rear end hook ring (232) of the third bed board section.

In one embodiment, the traction device (4) of the present disclosure provides linear traction to the thoracic spine, lumbar spine, and pelvis-lower limb region for stretching by connecting the electronic traction equipment (3) to the rear end hook ring (232) of the third bed board section and the rear end hook ring (242) of the fourth bed board section and stretching.

In one embodiment, the traction device (4) of the present disclosure simultaneously provides linear traction to the cervical, thoracic, lumbar spine, and pelvis-lower limb region for stretching by connecting the electronic traction equipment (3) to the front end hook ring (211) of the first bed board section and the rear end hook ring (242) of the fourth bed board section.

In one embodiment, the traction device (4) of the present disclosure provides linear traction to the pelvis-lower limb region for stretching by connecting the electronic traction equipment (3) to the rear end hook ring (242) of the fourth bed board section.

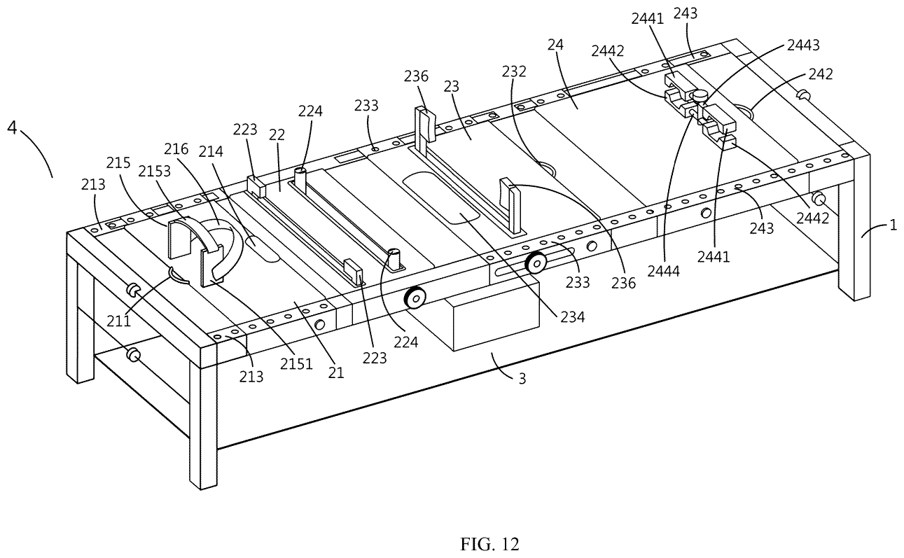

To better understand the overall structure of the device, a perspective structural diagram of the traction device (4) of the present disclosure is provided, as shown in FIG. 12.

FIG. 2 shows the electronic traction equipment (3) connected to two hook rings at a time. However, it is understood by those skilled in the art that the electronic traction equipment (3) may have three connecting lines to connect to three hook rings simultaneously, for example, the front end hook ring (211) of the first bed board section, the rear end hook ring (232) of the third bed board section, and the rear end hook ring (242) of the fourth bed board section, to provide simultaneous linear traction to the cervical, thoracic, lumbar spine, and pelvis-lower limb region for stretching.

The electronic traction equipment (3) of the present disclosure may be configured using methods known to those skilled in the art, such as having a touch panel or button panel for operator use, and may also include a remote control or a connection to a remote operation mode for user self-operation. During operation, traction parameters may be set, such as traction weight in pounds, stretching time, and intermittent time. Exemplary parameter settings are as follows: the traction weight parameters may start from one-seventh of the user's body weight and gradually increase to one-fourth, adjusted according to individual needs; the traction method is intermittent, typically stretching for 7 seconds in one cycle, then stopping for 15 seconds, repeating this cycle for 20 to 30 minutes.

In summary, the traction device (4) of the present disclosure has a novel and ingenious structural design, capable of linear stretching to achieve effective traction, alleviate discomfort, or promote healing. Considering safety and ease of operation in the overall design, the present disclosure is easy to use, allowing both professionals and ordinary individuals to operate and use the traction device of the present disclosure without safety risks.

### Second Embodiment

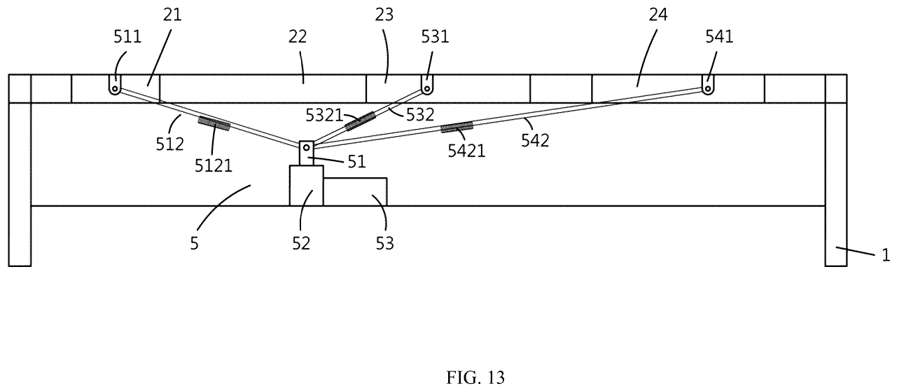

The traction device of the exemplary second embodiment of the present disclosure, as shown in FIG. 13, consists of a bed frame (1), a bed board (2), and hydraulic equipment (5) forming the traction device (4). The bottom of the multiple leg posts of the bed frame (1) is equipped with fixed wheels (not shown) to facilitate movement and stabilize the bed frame (1) after relocation.

The front leg posts and rear leg posts on the central axis of the bed frame (1) are each equipped with two rollers (11) at their top and middle positions. The rollers (11) are used to fix the traction ropes connecting the traction device to the hook rings, achieving the purpose of linear traction. The bed board (2) comprises four bed board sections: the first bed board section (21), the second bed board section (22), the third bed board section (23), and the fourth bed board section (24). The first bed board section (21), the second bed board section (22), the third bed board section (23), and the fourth bed board section (24) are each equipped with mattresses made of elastic materials such as sponge, foam, latex, silicone, or rubber. The hydraulic equipment (5) has a design structure known to those skilled in the art, such as an electric hydraulic bed, manual hydraulic bed, or manual hydraulic pallet truck, etc.

Slide rails (213) are set on both sides of the movable first bed board section (21). A linkage rod base (511) is installed at one-third the distance from the front end of the bottom of the first bed board section (21). The linkage rod (512) connects from the linkage rod base (511) to the hydraulic rod (51). When the hydraulic cylinder (52) of the hydraulic equipment (5) moves the hydraulic rod (51) up or down, it causes the first bed board section (21) to move parallel to the direction of the human body (X direction). The linkage rod may be detachable or fixedly connected to the hydraulic equipment (5).

The movable third bed board section (23) is equipped with slide rails (233) on both sides. A linkage rod base (531) is installed at one-third the distance from the front end of the bottom of the third bed board section (23). The linkage rod (532) connects from the linkage rod base (531) to the hydraulic rod (51). When the hydraulic cylinder (52) of the hydraulic equipment (5) moves the hydraulic rod (51) up or down, it causes the third bed board section (23) to move parallel to the direction of the human body (X direction).

The movable fourth bed board section (24) is equipped with slide rails (243) on both sides. A linkage rod base (541) is installed at a quarter of the distance from the rear end of the bottom of the fourth bed board section (24). The linkage rod (542) connects from the linkage rod base (541) to the hydraulic rod (51). When the hydraulic cylinder (52) of the hydraulic equipment (5) moves the hydraulic rod (51) up or down, it causes the fourth bed board section (24) to move parallel to the direction of the human body (X direction).

Except from the paragraphs described above, other elements and their technical features in the second embodiment may be set the same as in the first embodiment, referring to FIG. 3 to FIG. 10 and the corresponding descriptions above.

Accordingly, the traction device (4) of the present disclosure is designed for effective stretching while the user is lying flat, which is considered the most comfortable position and provides optimal stretching results. Moreover, the device features multiple fixing devices, stopper shafts, and stoppers to ensure linear stretching of the cervical, thoracic, and lumbar spine, as well as the pelvis-lower limb region, and prevents the distortion of force lines and the spine being unable to stretch in a straight line in previous technologies, which only stretch surface soft tissues without achieving simultaneous traction of the spine, pelvis, lower limbs, tendons, and ligaments.

In the embodiment of the present disclosure, the hydraulic equipment (5) may control the hydraulic rod (51) to move up or down between any two bed board sections using the hydraulic pump (53), thereby moving the linkage rod for traction and achieving the effect of human traction.

For example, as shown in FIG. 13, the hydraulic equipment (5) may connect the linkage rods (512, 532) and hydraulic rod (51) below the first bed board section (21) and the third bed board section (23). By controlling the hydraulic rod (51) to move up or down, the linkage rods move to both sides, stretching the cervical, thoracic, and lumbar spine of the human body.

In some embodiments, the linkage rod may be two-sectioned, with the junction connected by telescoping devices (5121, 5321, 5421) to accommodate users of different heights. By adjusting the tension of the telescoping devices (5121, 5321, 5421), the bed board may be set to a position that allows for effective stretching. For example, tightening the telescoping device (5121) shortens the linkage rod (512), suitable for shorter users; conversely, loosening the telescoping device (5121) lengthens the linkage rod (512), suitable for taller users.

The hydraulic equipment (5) of the present disclosure may be configured using methods known to those skilled in the art. For example, it may include a touch panel or button panel for operator use, or a remote control and connection to a remote operation mode for user control. During operation, traction parameters such as traction weight, stretching time, and interval time may be set when setting the hydraulic equipment (5). An exemplary setting is to start the traction weight at one-seventh of the user's body weight and gradually increase to one-fourth, adjusting as needed. The traction method is typically intermittent, stretching for 7 seconds followed by a 15-second pause, repeating this cycle for 20 to 30 minutes.

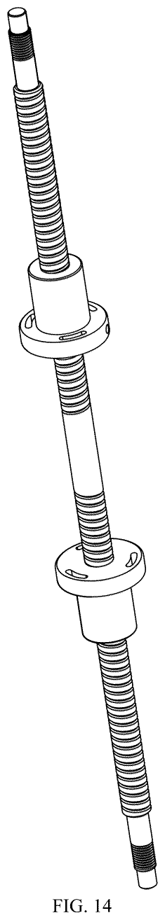

Additionally, to provide a clearer understanding of the screw rod structure in the present disclosure, a schematic perspective view of the screw rod is provided in FIG. 14, which may be used in the first and the second embodiment.

In summary, the traction device of the present disclosure has a cleverly designed structure that allows for linear traction of the affected area, providing effective stretching, relief of discomfort, or healing. The overall design takes into account safety and ease of operation, making the present disclosure simple to use. Both professionals and ordinary consumers may operate and use the traction device without any safety risks.

The terms used in this specification are for the purpose of describing particular embodiments only and is not intended to limit the present disclosure. As used in the present disclosure, the singular forms “a”, “an” and “the” do not imply a limitation on quantity and should be interpreted as including the plural form unless the context explicitly indicates otherwise.

All ranges disclosed in the present disclosure encompass the endpoints and all combinations of endpoints and intermediate values. The term “combinations thereof” includes one or more of the listed elements and is inclusive. It should also be understood that, as used in this specification, the term “comprising” specifies the presence of stated features, components, steps, and/or elements, but does not preclude the presence or addition of one or more other features, components, steps, elements, and/or combinations thereof.

The term “aspect” or “embodiment” refers to the relevant description of the aspect or embodiment that may be included in at least one aspect or embodiment of the present disclosure and may or may not be present in other aspects or embodiments.

While preferred embodiments have been described, it should be understood that those skilled in the art, now and in the future, may make various improvements and modifications that fall within the scope of the appended claims. These claims should be interpreted to maintain proper protection for the original disclosure.

What is claimed is:

1. A traction device, comprising:
a bed frame, and a bed board disposed on the bed frame;
the bed board comprises four bed board sections, which is a first bed board section, a second bed board section, a third bed board section, and a fourth bed board section respectively;
the first bed board section is movable by setting slide rails on both sides, and the first bed board section is provided with:
a cervical cushion, for placing a neck of a human body, which is made of elastic material, with a curvature corresponding to a human cervical spine;
a head fixing device, for completely accommodating a head of the human body, wherein a main body of the head fixing device is composed of an iron plate wrapped with elastic material, and a lower left end and a lower right end are respectively fixed to the first bed board section with iron pieces; the head fixing device is fixed to a user's forehead with a strap, and adhesive parts are respectively provided on left and right outer sides, with two ends of a chin strap connected to the adhesive parts;
the second bed board section is fixed, and the second bed board section is provided with:
a plurality of shoulder stoppers, providing counteracting force for stretching a cervical spine, the shoulder stoppers are composed of an iron plate wrapped with elastic material, the shoulder stoppers are installed on the second bed board section with a rotating shaft rod, the shoulder stoppers are slightly inclined forward by 25 degrees to match a curvature of a human shoulder and neck;
when not in use, the shoulder stoppers are stored parallel downwards; when in use, the shoulder stoppers may rotate upwards to rest against an upper end of the human shoulder, and may slide in a direction parallel to a width of the bed board, adjusted to an appropriate position of a shoulder peak according to a width of the human shoulder, and then fixed;
a plurality of armpit stopper shafts, providing counteracting force for stretching a thoracic and lumbar spine, the armpit stopper shafts are composed of iron shafts wrapped with elastic material, respectively fixed under armpits on both sides of the human body, the armpit stopper shafts are installed with shaft rods;
when not in use, the armpit stopper shafts are stored parallel downwards; when in use, the armpit stopper shafts may rotate upwards to resist human armpits, and may slide left and right in the direction parallel to the width of the bed board, adjusted to an appropriate position according to a width of the human armpits, and then fixed;
the third bed board section is movable by setting slide rails on both sides, and the third bed board section is provided with:
a lumbar cushion, for placing a waist of a human body, with a curvature corresponding to a human lumbar spine;
a plurality of iliac stoppers, the iliac stoppers are composed of an iron plate wrapped with elastic material, respectively used to fix an upper edge of an iliac crest on both sides of the human body, the iliac stoppers are installed with shaft rods, and designed to be slightly inclined forward by 5 degrees; when not in use, the iliac stoppers are stored parallel downwards, and when in use, the iliac stoppers are rotated upwards and adjusted to an appropriate position according to an user's body shape, and then fixed;
the fourth bed board section is movable by setting slide rails on both sides, and the fourth bed board section is provided with:
a plurality of foot fixing devices, covering feet of the human body, having an upper part and a lower part, the upper part is made according to a curvature of a dorsum of a human foot, the lower part is made according to a curvature of a heel of a human ankle, the upper parts are connected by a connecting component, the lower parts are connected by another connecting component, the upper part and the lower part may be adjusted to an user's foot shape by adjusting the connecting component.

2. The traction device according to claim 1, wherein the armpit stopper shafts and/or the iliac stoppers are installed in a manner using shaft rods comprising screw rod rotating wheels and screw rods.

3. The traction device according to claim 1, wherein a front end of the first bed board section, a rear end of the third bed board section, and a rear end of the fourth bed board section are respectively provided with hook rings connected to an electronic traction equipment;
according to an user's needs for stretching parts, the electronic traction equipment is connected to corresponding hook rings, when the electronic traction equipment pulls the bed board sections and stretches the human body in a direction parallel to the human body and away from a center of the second bed board section, the plurality of stoppers, the plurality of stopper shafts, and the foot fixing devices provide counteracting force, allowing the traction device to stretch a cervical spine, thoracic spine, lumbar spine, pelvis, and lower limbs of a human body.

4. The traction device according to claim 1, wherein the cervical cushion has an arc-shaped structure that is higher on both sides and gradually arches inward, having a physiological curvature of a cervical spine ranging from 22 to 24 degrees from both sides to a center concave portion.

5. The traction device according to claim 1, wherein the lumbar cushion has an arc-shaped structure that is lower on both sides and gradually arches inward, the arch has a curvature of 26 degrees corresponding to a human lumbar spine from both sides to a center raised portion.

6. The traction device according to claim 1, wherein the iliac stoppers are designed based on a structure of the upper edge of the iliac crest and are slightly inclined forward by 5 degrees.

7. The traction device according to claim 3, wherein the electronic traction equipment connects to the hook ring at the front end of the first bed board section to apply linear traction to the cervical spine of a human body for stretching; or
the electronic traction equipment connects to the hook rings at the front end of the first bed board section and the hook rings at the rear end of the third bed board section to simultaneously apply linear traction to the cervical, thoracic, and lumbar spine of the human body for stretching; or
the electronic traction equipment connects to the hook rings at the front end of the first bed board section, the hook rings at the rear end of the fourth bed board section, and optionally the hook rings at the rear end of the third bed board section to simultaneously apply linear traction to the cervical, thoracic, lumbar spine, and pelvis-lower limb region of the human body for stretching.

8. The traction device according to claim 3, wherein the electronic traction equipment connects to the hook ring at the rear end of the third bed board section to apply linear traction to the thoracic and lumbar spine of a human body for stretching; or
the electronic traction equipment connects to the hook rings at the rear end of the third bed board section and the hook rings at the rear end of the fourth bed board section to simultaneously apply linear traction to the thoracic, lumbar spine, and pelvis-lower limb region of the human body for stretching.

9. The traction device according to claim 3, wherein the electronic traction equipment connects to the hook ring at the rear end of the fourth bed board section to apply linear traction to the pelvis-lower limb region of the human body for stretching.

10. A traction device according to claim 1, comprising: an electric pump controlling a hydraulic rod between any two of the first bed board section, the third bed board section, and the fourth bed board section, which in turn moves a linkage rod back and forth for stretching, the linkage rod is two-sectioned, connected at a junction of the two sections with an extender, allowing for adjustment to suit users of different heights, by adjusting a tension of the extender, the bed board is set to an effective stretching position, users may adjust the hydraulic rod's vertical movement to apply linear traction to the cervical, thoracic, lumbar spine, and pelvis-lower limb region for stretching.
